(19) United States
(12) Patent Application Publication
(10) Pub. No.: US 2003/0196594 A1
(43) Pub. Date: Oct. 23, 2003

(54) Spraying apparatus

(76) Inventor: Charles R. Reed, Vandalia, MI (US)

Correspondence Address: Walter D. Ames, 6718 Wemberly Way, McLean, VA, 22101, US

(21) Appl. No.: 10/123,477

(22) Filed: Apr. 17, 2002

(51) Int. Cl. B05C 11/02; B05C 13/02

(52) U.S. Cl. 118/52; 118/319; 118/324

(57) ABSTRACT

Apparatus for spraying paint on a can or can top includes a carrier for the article, the carrier being formed of with a pedestal, a shaft extending upwardly from the pedestal, and an adapter mounted on the shaft. The adapter engages the article and causes it spin as the carrier spins at the spray painting station. Further, a bottom plate of the apparatus is formed with a slot through which the carrier shaft extends, thereby shielding lower portions of the apparatus from inadvertent spraying. Additionally, the apparatus positions individual carriers at the spraying station by means of a rotatable disc in which a slot that extends from the periphery toward the center of the disc engages the shaft of a carrier and, as the disc rotates, moves the shaft and the can it carries to the desired

### FIELD OF INVENTION

The present invention relates in general to apparatus, and any method performed by that apparatus, for spraying or otherwise handling articles of manufacture. More specifically, the invention relates to apparatus for spray painting cans and can tops.

### BACKGROUND OF INVENTION

It has become highly efficacious for articles such as cans and can tops to be spray painted prior to being transported into an oven where the painted cans are baked to dry or set the paint sprayed on them. Systems have been devised for such transport, the cans being moved by a pin chain conveyor, and U.S. Pat. No. 4,274,532 discloses a system in which cans with an open end are moved by can carriers on which the cans have been placed open-end-down. The carriers and their surmounted cans are then carried by a conveyor belt and each carrier, which supports four invented cans, is sequentially moved to a spraying station where the carrier is rotated to bring each of the cans into the path of the spray gun. Thereafter the carriers are moved to an oven where the cans are baked to dry the paint or varnish or other material that has been sprayed on them.

Several difficulties have arisen with regard to the system described herein as prior art. One of the problems exists because the inverted can is in direct contact with the can carrier. With this configuration, the rim of the can or article of manufacture is not subject to being contacted by sprayed material. Thus, after the cans emerge from the oven, their rims will not have been sprayed, and the painting must either be completed by hand or some other means must be devised so that the can or can top will not exhibit a slovenly appearance at its rim, where the absence of paint is likely to be noticed.

Still another problem with prior art systems of which I am aware is the fact that at any spray painting station, the paint or varnish or other liquid droplets that are being propelled toward the article must, of necessity, be sprayed over a considerable field in order to completely paint the object. Thus, paint spray is likely to cause the article at which it is directed to be sprayed, as well as other parts of the apparatus that conveys the cans. When carriers such as those described in the prior art system are used, those carriers are in the direct path of the paint spray. Thus, clean-up of the carriers and other parts of the apparatus that have inadvertently been subjected to paint can become a major task. Yet if such clean-up is not performed, the portions of the system that still bear traces or even more of the prior point job can seriously damage the integrity of the articles that are next subjected to paint spraying on the same device.

It is, therefore, a primary object of my invention to provide an apparatus for paint spraying articles of manufacture in which the entirety of the articles, such as cans and can tops, will be subjected to the paint spray and be uniformly covered by the paint being applied.

It is another object of the present invention to provide such an apparatus in which masking means are provided to minimize any clean-up that may be necessitated by errantly directed paint spray that does not alight on the articles to be coated.

### SUMMARY OF INVENTION

The present invention is directed to spray painting articles of manufacture having a centrally located orifice therein, for example, empty aerosol cans or can tops. Means are provided for holding these articles in a pendent position, such means including a pedestal on which the article is mounted. The pedestals, with the cans supported by them, are moved toward a spraying station. As the pedestals, which are normally in adjoining relationship, approach the spraying station, they are separated and individually brought to the station, where they are rotated and, while rotating, sprayed. Thereafter the pedestals and the cans they carry are moved from the spraying station and, if desired, to an oven, where the pedestals are brought into abutting relationship although their cans, newly painted, are in spaced relationship.

The means for rotating the pedestals and cans at the spraying station involves structure that is part of one aspect of my invention. Mounted on each pedestal is a vertical shaft that extends upwardly from the pedestal. The shaft terminates upwardly in means, such an adapter, that cooperates with the article and extends into the central orifice of the article or can. In this manner the can will be positioned above the pedestal but separated from it by the shaft which, if both it and the pedestal are circular in cross-section, will have a substantially lesser diameter than the pedestal. Still, rotation of the pedestal will result in rotation of the can.

Defining one embodiment of the means for rotating the can more particularly, the adapter that is attached to or of one piece with the upward end of the shaft may be of a greater diameter than the shaft. So, it can be of the approximate inner diameter of the can or can top such that the adapter and the can top cooperate frictionally with one another, i.e., when the adapter spins, so does the can top. In another embodiment the can top has an interior, depending clamp and the adapter atop the shaft is of a size and shape that it can be clamped to the can so that the two will rotate together. Where the article to be sprayed is an open-ended can, simply inserting the carrier shaft into that open end will result in sufficient engagement that the carrier and article will rotate together.

Another important aspect of the present invention is directed toward confining errant spray at the spraying station from coating portions of the apparatus, where such coating will not only present an undesirable appearance but may be transferred to a subsequent group of articles that are being sprayed with a different material. One element of such masking is the provision of a substantially horizontal wall or plate located beneath the articles to be sprayed, but protecting lower portions of the apparatus, e.g., the pedestals, from inadvertent spraying. In order to mask the pedestals, the horizontal wall is provided with an elongated slot of a width sufficient to permit the shaft that extends upwardly from the pedestal to move within the slot. As the width of the slot accommodates the shaft but not the pedestal of any rotating means, protection is provided for the pedestal except for such small amount of paint that may find its way through the slot in the bottom wall of the housing.

As masking does relieve the considerable burden of clean-up after a batch of cans has been sprayed, it has also been found desirable to provide a housing or enclosure that surrounds the spray station. In this embodiment the pedestals and the cans carried thereby enter the housing through an opening in one end wall, pass through the spray station, and from the housing at an opening in the other end wall. The housing will have a slotted bottom wall as well as a back wall and roof so that it will enclose the spray station.

Another aspect of the invention is directed to the means for separating the can carriers that are in a line on the conveyor belt and moving them individually to the station where they will be rotated and sprayed. In a preferred embodiment this is accomplished by the utilization of a horizontally disposed disc that has one or more slots located along its periphery and extending into the body of the disc, preferably toward the center thereof. The periphery extends into the path of the carriers, and when a slot of suitable dimensions is reached, the stem of the carrier passes into the slot and the carrier is brought to the spraying station. Other carriers must wait in line until another slot is reached, and further rotation of the disc will then bring the carrier at the spraying station to an outlet position on the conveyor belt and a new carrier to the station at which it will be rotated and sprayed.

These and other objects, features and advantages of my invention will become more apparent when considered in connected with preferred embodiments thereof as described hereinafier and illustrated in the accompanying drawings, in which:

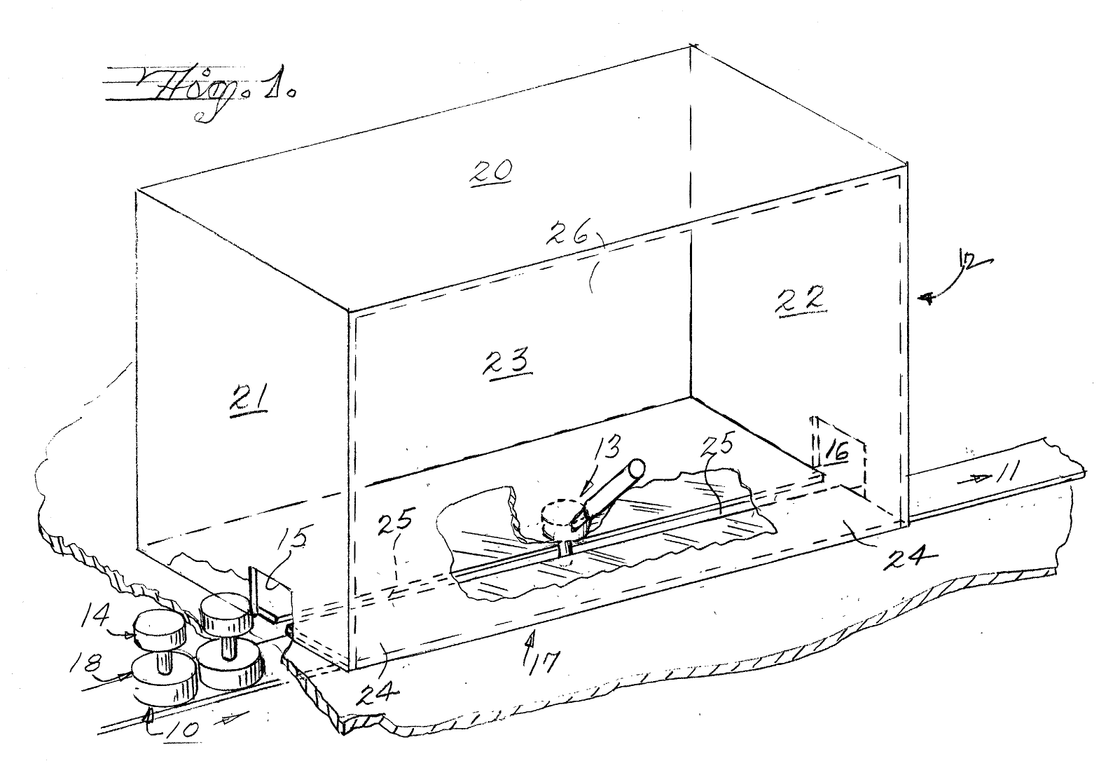

FIG. 1 is an overall view in perspective showing various elements of the apparatus embodying my invention;

FIG. 2 is a top plan view showing a portion of the apparatus of FIG. 1;

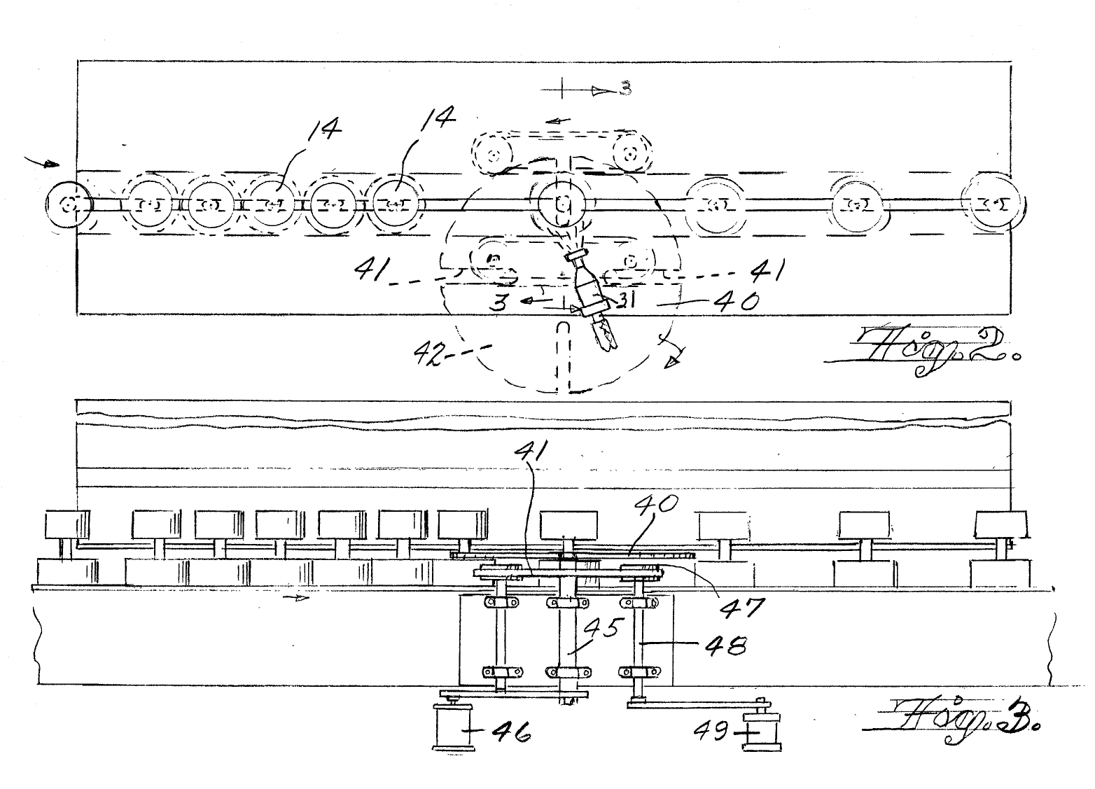

FIG. 3 is a section taken along the line 3-3 of FIG. 2;

FIG. 4 is a detail of the spraying means of the invention;

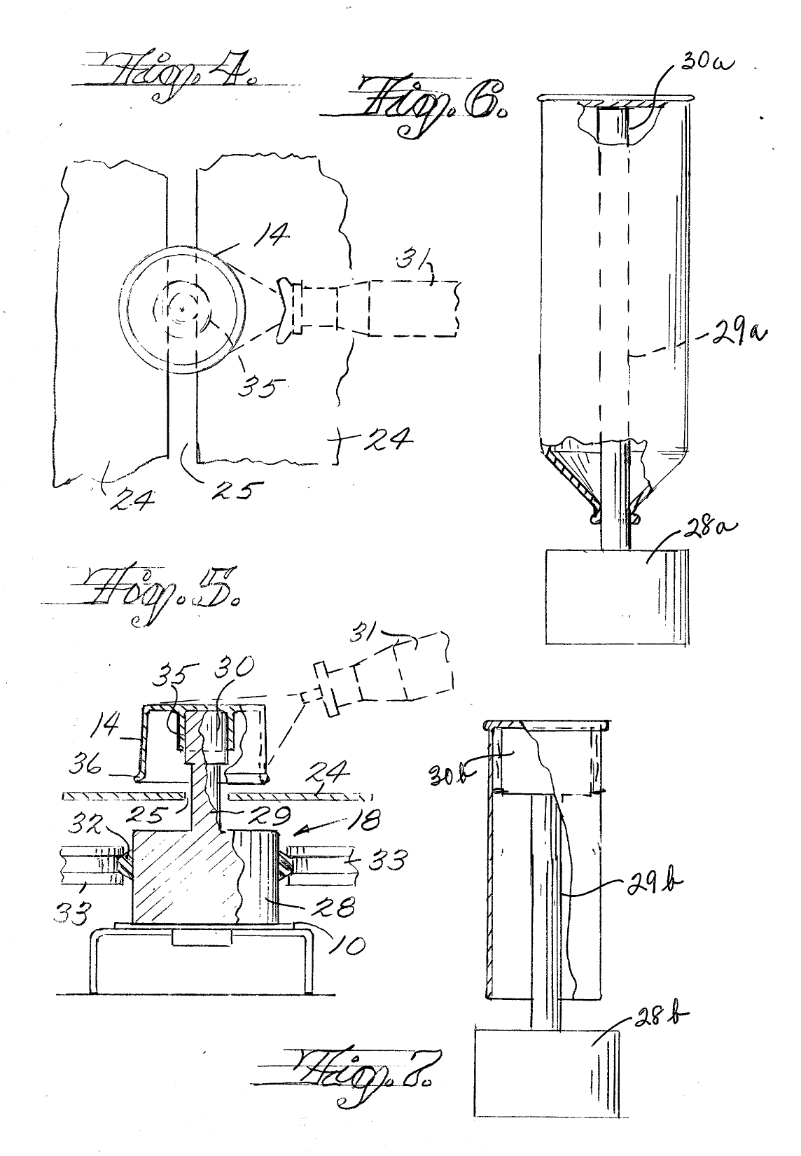

FIG. 5 is a side elevational view, partly in section, of one embodiment of a can carrier;

FIG. 6 is an elevation of another embodiment of the can carrier, and

FIG. 7 is an elevation of still a third embodiment of the carrier of the invention.

### DETAILED DESCRIPTION OF PREFERRED EMBODIMENTS

Referring now to the drawings, and in particular to FIG. 1 thereof the apparatus embodying my invention comprises a conveyor, indicated generally by the reference numeral 10, which moves in the direction of the arrows 11 through an enclosure 12. Within enclosure 12 is a spraying station, indicated generally at 13, at which articles of manufacture that are to be painted or otherwise treated are subjected to liquid in the form of a spray. Those articles, identified by reference numeral 14, are mounted on carriers 18 transported by conveyor 10 into the enclosure 12 through an entrance 15 in the enclosure, and exit the enclosure through a complementary opening 16 at the far end of the enclosure 12. At the spray station 13 the articles 14 are rotated by spinning means, indicated as a whole by numeral 17, 50 that paint can be evenly applied to the entirety of the outer surface of the article.

The enclosure 10, which serves the purpose of preventing errant spray from coating unwanted parts of the apparatus, is best illustrated in FIG. 1. It will there be seen that the enclosure 12 consists of a top wall 20, opposed end walls 21 and 22, a back wall 23, front wall 26, and a bottom wall 24. It is a feature of my invention that bottom wall 24 is provided with an elongated slot 25 which, in the preferred embodiment, extends for the entirety of the bottom wall and between the end walls 21 and 22 of the enclosure.

The purpose of slot 25 in bottom wall 24 is to cooperate with and allow the articles of manufacture 14, as they are mounted on their carriers 18, to pass through the enclosure 12. Thus, the structure of the carriers for the articles 14 is designed for such cooperation. One embodiment of such carriers is seen in FIGS. 4 and 5. There the carrier 18 is formed with a pedestal 28, shown positioned on conveyor 10. Formed integral with pedestal 28 and extending upwardly therefrom is a stem or shaft 29 surmounted by an adapter 30. Of course, while these portions of the carrier 27 are illustrated as being formed in one piece, it will be apparent that they can be individual elements capable of being separated and replaced, if necessary, with elements of different sizes and shapes.

Also shown in FIG. 5 is a spray mechanism, illustrated diagrammatically at 31, which sprays paint, varnish or other coating at the exterior of the article 14, which as illustrated is a form of aerosol can top. Pedestal 28 is rotated at its station on the conveyor 10 by means of belts 32 that frictionally engage the outer surface of pedestal 28 and, impelled by pulleys 33, spin the pedestal 28 and its associated shaft 29, adapter 30 and can top 14. As will be apparent, the adapter 30 as illustrated in FIG. 5 is of substantially lesser diameter than the inner diameter of the can top or article 14. So, in order to spin the can top, adapter 30 in FIG. 5 is sized to fit within an interior flange 35 that depends from inside the roof of the article 14. In this manner the adapter 30 transmits its torque to the flange 35 and article 14 so that the article is spun by belts 32 and is evenly sprayed, even to the lower rim 36 of the article, which spraying cannot be effected if the article rests on any surface.

Variations of the structure of the carrier 27 are shown in FIGS. 6 and 7. In FIG. 6 the adapter 30a is of the same diameter of the shaft 29a, fixed to the pedestal 28a. Here the adapter 30a holds an inverted can body 37. While the adapter 30a does not frictionally engage the entirety of the interior of the can body 37, as it spins it causes the can body to spin with it. In FIG. 7 the adapter 30b which surmounts stem 29b attached to pedestal 28b does have a diameter only slight less than the inner diameter of the can top, so that when the adapter spins the can top will spin with it.

It is another aspect of the present invention that portions of the apparatus, e.g., the carrier pedestals and the conveyor, not be subjected to paint sprayed to cover the exterior of the can top or can body. For this reason, as shown in FIG. 1, a housing 12 is provided so that indiscriminately applied spray will be substantially confined. Illustrated in FIGS. 4 and 5 of the drawings are enlarged views that show the importance of the bottom wall 24 of housing 12. The bottom wall 24 is, as described with regard to FIG. 1, formed with an elongated slot 25. That bottom wall and slot are prominent in FIGS. 4 and 5. As seen shaft 29 of carrier 18 is located in the slot 25. The pedestal 28 of carrier 18 is of too large a size for it to fit through the slot 25. Thus, portions of the apparatus below bottom wall are shielded from the sprayed paint, and the edges of slot 25 serve the added function of maintaining the carriers in alignment and keeping them from straying off the conveyor belt.

Another feature of my apparatus resides in the manner in which the carriers 18, which are in pedestal-to-pedestal alignment as they proceed down the line on conveyor belt 10 toward the spray station 13, are separated and individually brought a position in which they can be sprayed by sprayer 31. Such apparatus is best seen in FIGS. 2 and 3. As there shown, a rotary disc is cut with slots 41 that extend from the periphery of the disc toward the center thereof. In those Figures the slots extend perhaps two-thirds of the distance from the periphery to the center of the disc, but such distance can be varied to suit individual circumstances of desired slot performance.

As a line of carriers 18 approaches the disc 40, that disc rotates so that a slot 41 intersects the line of carriers and the articles 14 carried by them. During such rotation a slot 41, properly sized, grasps the stem or neck 29 of the forwardmost carrier 18 and, on continued rotation of the disc 40, that carrier will be moved to the position shown in FIG. 2 at the spray station 13. At the same time the next carrier in the line will not be able to contact a slot until, in this embodiment, disc 40 has rotated another 90 degrees. The next carrier will contact the periphery 42 of disc 40, and the periphery 42 will cause the next-in-line carrier to remain in position on the conveyor until it, too, is moved as it passes within the next slot of the disc.

The drive mechanisms for the apparatus are shown in FIG. 3. In this side elevational view the disc 40 is shown as mounted on a drive shaft 45 powered by motor 46. Belt 41 is mounted for rotation of pulley 47, which is itself mounted on drive shaft 48 and powered by motor 49. As the means for powering the various mechanical elements of the apparatus are well within the skill of those in this art, they have not be illustrated in great detail.

Rotation of the disc 40 will, in this embodiment, be intermittent, according to the length of time needed to maintain the article at the spraying station. After spraying has been completed, the disc 40 will be rotated another 90 degrees, which will accomplish two functions: enabling the next-in-line carrier to be grasped by the approaching slot and brought to the spray station, and releasing the sprayed article for spaced movement toward the exit 16 in the end wall 22. Thereafter the carriers and the articles that they bear may be moved so that their pedestals are in abutting relationship; however, it should be noted that the pedestals of the carriers are of a greater lateral dimension than the adapters they carry and the articles borne by the adapters. Thus, although the carriers 18 may be in contact with each other through their pedestals 28, the articles 14 carried by those pedestals are not in contact, which is important when such paint-sprayed articles proceed on the conveyor belt to an oven into which they may be loaded in abutting relationship, to be baked until the paint has dried.

It will be apparent to those of skill in this art that alterations and modifications may be made to the invention described and illustrated in this patent without departing from the spirit of the invention. As to all such alterations and modifications, it is desired that they be included within the purview of the invention, which is to be limited only by the scope, including equivalents, of the following, appended claims.

1. Apparatus for spray painting articles of manufacture having a centrally located orifice therein, comprising
means holding said articles so that they move individually therewith, said holding means including a pedestal on which each said article is removably mounted,
means for moving said pedestals of said holding means toward a spraying station,
means for separating said pedestals at said spraying station so that they are individually located at said station,
means for rotating said articles at said spraying station, said rotating means comprising a shaft fixed to each said pedestal and extending upwardly therefrom, said shaft terminating upwardly in means cooperating with said article and extending into said centrally located orifice thereof and positioning said article above and out of contact with said pedestal,
means for spraying each said article at said spraying station as said article is rotated by said rotating means, and
means for moving each said article from said spraying station after it has been sprayed.

2. Apparatus for spray painting articles of manufacture as claimed in claim 1, in which said means cooperating with said article is in the form of a cylinder having a diameter greater than the diameter of said shaft.

3. Apparatus as claimed in claim 2, in which each said article is a can top and said cylinder has a diameter of the size of the inner diameter of the orifice of said can top so that said can top cooperates frictionally with said cylinder and rotates therewith.

4. Apparatus as claimed in claim 1, in which said rotating means comprises means for rotating said pedestal of said holding means, so that said pedestal, shaft, cooperating means and article are simultaneously rotated at said spraying station as said spraying is effected.

5. Apparatus as claimed in claim 1, said articles having means located in their centrally located orifices for grasping and holding said cooperating means as each said pedestal is rotated at said spraying station.

6. Apparatus for spray painting articles of manufacture having a centrally located orifice therein, comprising
means holding said articles so that they move individually therewith, said holding means including a pedestal on which each said article is removably mounted,
means for moving said pedestals of said holding means toward a spraying
means for separating said pedestals at said spraying station so that they are individually located at said station,
means for rotating said articles at said spraying station, said rotating means comprising a shaft fixed to each said pedestal and extending upwardly therefrom, said shaft terminating upwardly in means cooperating with said article and extending into said centrally located orifice thereof and positioning said article above and out of contact with said pedestal,
means for spraying each said article at said spraying station as said article is rotated by said rotating means,
means for masking parts of said apparatus at said spraying station so that they are protected from paint that does not contact said articles, and
means for moving each said article from said spraying station after it has been sprayed.

7. Apparatus as claimed in claim 6, in which said masking means includes a substantially horizontal wall located beneath said articles as they are sprayed and protecting parts of the apparatus below said articles.

8. Apparatus as claimed in claim 7, in which said substantially horizontal wall is formed with an elongated slot located at a height above said pedestals but below said article cooperating means of said rotating means, so that said articles are positioned at said spraying station with said shaft located in said slot and said pedestal substantially masked from sprayed paint.

9. Apparatus as claimed in claim 6, in which said masking means includes a backing plate located behind said articles as they are sprayed and protecting parts of said apparatus on the side thereof away from said spraying station.

10. Apparatus as claimed in claim 6, in which said masking means is an enclosure having top, bottom and side walls, said side walls being formed with apertures therein through which said pedestals enter and exit, and said bottom wall being formed with an elongated slot located at a height above said pedestals but below said article cooperating means of said rotating means, so that said articles with said enclosure are positioned are positioned with said shaft of said rotating means located in said slot and said apparatus substantially masked from sprayed paint.

11. Apparatus as claimed in claim 1, in which said rotating means includes power-driven, belts with flights that move in opposite directions and straddle said pedestals at said spraying station to effect rotation of said pedestals.

12. Apparatus for spray painting articles of manufacture having a centrally located orifice therein, comprising
means holding said articles so that they move individually therewith, said holding means including a pedestal on which each said article is removably mounted,
means for moving said pedestals of said holding means toward a spraying station in a position in which said pedestals are in a line and adjoin each other;
means for separating said pedestals at the entrance of said spraying station, said separating means transporting one said pedestal at a time to said spraying station so that one of said pedestals and the article it carries are individually passed through said station;
means for rotating each said article at said spraying station,
means for spraying each said article at said spraying station as said article is rotated by said rotating means, and
means for moving each said article from said spraying station after it has been sprayed.

13. Apparatus as claimed in claim 12, in which said separating means includes a rotatable disc having at least one slot extending from its periphery toward the interior of said disc, said disc extending into said line of pedestals and rotating untie one of said holding means is located within said one slot, said disc, on further rotation, transporting said one holding means within said slot to said spraying station.

14. Apparatus as claimed in claim 12, in which said disc has four slots equally spaced along its periphery.

15. Apparatus as claimed in claim 12, said articles having means located in their centrally located orifices for grasping and holding said cooperating means as each said pedestal is rotated at said spraying station.

16. Apparatus as claimed in claim 12, in which said rotating means comprises means for rotating each said pedestal of said holding means, so that said pedestal, shaft, cooperating means and article are simultaneously rotated at said spraying station as said spraying is effected.
